(19) United States
(12) Patent Application Publication
(10) Pub. No.: US 2023/0338796 A1
(43) Pub. Date: Oct. 26, 2023

(54) GOLF BAG CARRIER

(71) Applicant: Jerry Virgo, Mayfield Heights, OH (US)

(72) Inventor: Jerry Virgo, Mayfield Heights, OH (US)

(21) Appl. No.: 18/136,114

(22) Filed: Apr. 18, 2023

Related U.S. Application Data
(60) Provisional application No. 63/333,271, filed on Apr. 21, 2022.

(51) Int. Cl. A63B 55/60; B62B 1/12; B62B 5/06

(52) U.S. Cl. CPC A63B 55/60; B62B 1/12; B62B 5/067; B62B 2205/06; B62B 2202/404

(57) ABSTRACT

A collapsible golf cart for transporting golf clubs in a substantially upright position wherein the collapsible golf cart is structured to permit removal of a golf club bag after the golf club cart has been folded to a non-use position. A bag supporting frame assembly which is supported by the foldable leg assembly on which a pair of wheels are mounted in spaced, parallel relation to one another. The collapsible golf cart maneuvered by a handle secured to the upper end of the bag supporting frame assembly.

### CROSS-REFERENCE TO RELATED APPLICATIONS

This application claims the benefit of U.S. Provisional Patent Application No. 63/333,271 filed on Apr. 21, 2022 which is incorporated by reference in its entirety herein.

### TECHNICAL FIELD

This application relates to a golf bag carrier and more particularly to a collapsible golf carrier for transporting golf clubs that is structured to permit removal of the golf club bag after the golf club cart has been folded or collapsed to a non-use position.

### BACKGROUND OF THE INVENTION

Although the purists in the golf community insist that the only way to properly play golf is to carry the golf bag, either personally or through the use of a caddy, many golfers prefer to use carts to transport the golf bags and associated equipment. While riding carts are required by many courses, a great number of players desire to gain the exercise benefits of walking during the round, without carrying the bag and equipment. For this reason walking carts are popular.

Transporting a golf bag loaded with a full set of clubs is a less than enjoyable task for most players, especially senior citizens. Lifting the loaded bag in and out of an automobile trunk or sport utility vehicle storage area onto a golf cart requires that the bag is shifted from vertical to horizontal and back to vertical. The awkwardness presented by such shifting creates undue strain on the back and shoulder muscles that could cause an injury. Also, the bag and the automobile are subjected to unnecessary wear and tear when the bag is jammed into the trunk with the bags of the other players in the foursome.

Vacations present a whole new set of problems. Getting a heavy, fully loaded bag along with other luggage to the airport, on an airplane and to the hotel can often be a vacation-dampening chore. A combination golf bag storage and carrier device designed to alleviate the afore-mentioned problems would be a welcome addition in the art.

### SUMMARY OF THE INVENTION

According to the present invention, a collapsible golf cart for transporting golf clubs in a substantially upright position wherein the collapsible golf cart is structured to permit removal of a golf club bag after the golf club cart has been folded to a non-use position. A bag supporting frame assembly which is supported by the foldable leg assembly on which a pair of wheels are mounted in spaced, parallel relation to one another. The collapsible golf cart maneuvered by a handle secured to the upper end of the bag supporting frame assembly.

### BRIEF DESCRIPTION OF THE DRAWINGS

The structure, operation, and advantages of the present invention will become further apparent upon consideration of the following description taken in conjunction with the accompanying figures (Figs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a sideview of a golf cart in an upright position, in accordance with the present invention.

FIG. 2 is a front view of a golf cart in a collapsed position, in accordance with the present invention.

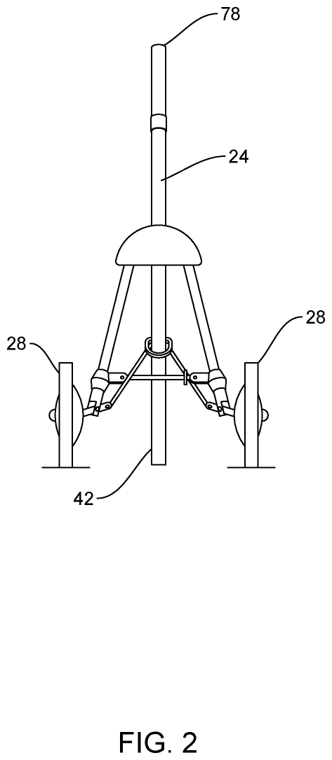

FIG. 3 is a rear view of a golf cart in an unfolded position, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

This invention relates to a collapsible golf cart 20 for transporting golf clubs and is structured to permit removal of a golf club bag 22 after the golf club cart has been folded or collapsed to a non-use position.

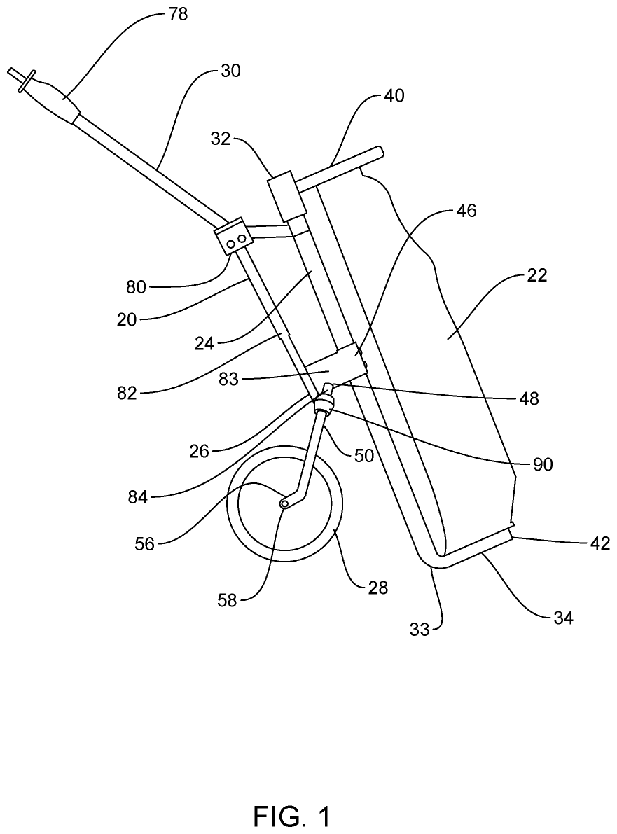

Referring to the drawings, FIG. 1 shows a collapsible golf cart 20 embodying the present invention which is adapted for carrying a golf bag 22 in a substantially upright position. The golf cart 20 comprises a bag supporting frame assembly 24 which is supported by the foldable leg assembly 26 on which a pair of wheels 28 are mounted in spaced, parallel relation to one another. The collapsible golf cart 20 is maneuvered by means of a handle 30 secured to the upper end of the bag supporting frame assembly 24.

As to the details of the construction, the bag supporting frame assembly 24 includes a tubular frame element 32, the lower end 33 thereof being bent outwardly at right angles to accommodate a bag supporting plate 34. Secured at upper and lower positions on the tubular frame element 32 are bag securing means 36 and 38, each of which includes brackets 40 and 42, respectively, extending from the frame element for the pivotal support of bag holding members 40 and 42. Belts passing through apertures in the bag holding members 40 and 42 provide adjustment to accommodate bags of various sizes and shapes.

Secured to the tubular frame element 32, such as by rivets, is a leg securing bracket 46 formed to provide rearwardly and outwardly directed slots 48 within which tubular external legs 50 are pivotally secured by means such as rivets. The outer ends 54 of the bracket are angled to form stops for the external legs in the open position.

The lower end of each external leg 50 is slotted at 56 to receive an axle 58 which is pivotally secured by a rivet. A wheel 28 is journaled on the outer end of each axle 58, and is maintained in position by conventional retaining means.

The handle 30 is secured to the upper end of the frame element 32. The handle may be pivoted in a vertical plane to the folded position. A handgrip 78 is provided on the outer end of the handle.

A connecting arm 82 extends downwardly from a pivot clamp 80 on the handle and links the handle with a yoke assembly 83 adapted for controlling the position of the foldable leg assembly. The lower end of the connecting arm 82 terminates in the fork arms 84 which are bored to receive the yoke arm 86. The ends of the yoke arm 86 are pivotally attached by rivets 88 to the forked extensions 90 of bushings 92 which are adapted to slide along the external legs 50. As can readily be understood, the folding leg assembly is controlled by movement of the handle for convenience in folding and unfolding the cart.

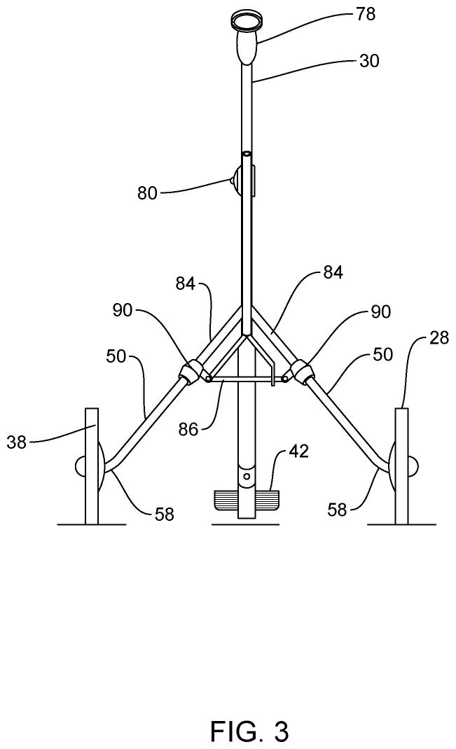

For normal use, the handle 30 is positioned as shown in FIG. 1 wherein the connecting arm 82 and yoke assembly 83 are in a raised position thus positioning the wheels in the widespread relation shown in FIG. 4. To collapse the cart, the handle 30 is pivoted downwardly into the position shown in FIG. 3, thus causing a downward movement of the connecting arm 82 and a resultant inward and forward folding of the legs due to the downward movement of the yoke assembly. It will be noted that the wheels remain parallel even in the folded position to permit a wheeling of the collapsed cart into or out of a storage area.

As shown in FIG. 3, the wheels upon collapse move forwardly into close relationship with the frame assembly 24 to form a compact package. Raising of the handle to the position shown in FIG. 1 automatically unfolds the legs to prepare the cart for normal duty. For folding or unfolding the legs, the cart is preferably tilted forward and balanced on the lower end 33 of the frame element 32 so that the wheels clear the ground during the transition period.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A collapsible golf cart for transporting golf clubs in a substantially upright position, comprising:
the collapsible golf cart structured to permit removal of a golf club bag after the golf club cart has been folded to a non-use position;
a bag supporting frame assembly which is supported by the foldable leg assembly on which a pair of wheels are mounted in spaced, parallel relation to one another; and
the collapsible golf cart maneuvered by means of a handle secured to the upper end of the bag supporting frame assembly.

2. The bag supporting frame assembly of claim 1 including a tubular frame element has a lower end thereof being bent outwardly at right angles to accommodate a bag supporting plate.

3. The bag supporting frame assembly of claim 2 wherein the tubular frame element has bag securing means extending from the frame element for pivotal support of bag holding members.

4. The bag supporting frame assembly of claim 3 wherein the bag securing means extending from the tubular frame element for the pivotal support of the bag holding members includes brackets secured at upper and lower positions on the tubular frame element.

5. The bag supporting frame assembly of claim 4 belts passing through apertures in the bag holding members provide adjustment to accommodate bags of various sizes and shapes.

6. The bag supporting frame assembly of claim 5 wherein the lower end of the frame tubular frame element has a bag supporting plate.

7. The bag supporting frame assembly of claim 6 wherein the is bent outwardly at right angles to accommodate bag supporting plate.

8. The bag supporting frame assembly of claim 7 wherein a leg securing bracket has rearwardly and outwardly directed slots within which tubular external legs are pivotally secured.

9. The bag supporting frame assembly of claim 8 wherein the leg securing bracket has outer ends angled to form stops for the tubular external legs in the open position.

10. The bag supporting frame assembly of claim 9 wherein the lower end of each of the external leg is slotted to receive an axle.

11. The bag supporting frame assembly of claim 10 wherein a wheel is journaled on the outer end of each axle.

12. The bag supporting frame assembly of claim 12 wherein a handle is secured to the upper end of the tubular frame element.

13. The bag supporting frame assembly of claim 13 wherein the handle is secured to the upper end of the tubular frame element so as to pivot in a vertical plane to dispose the collapsible golf cart in the folded position.

14. The bag supporting frame assembly of claim 14 wherein a connecting arm extends downwardly from a pivot clamp on the handle and links the handle with a yoke assembly adapted for controlling the position of the foldable leg assembly.

15. The bag supporting frame assembly of claim 15 wherein a lower end of the connecting arm terminates in fork arms which are bored to receive a yoke arm.

16. The bag supporting frame assembly of claim 16 wherein ends of the yoke arm are pivotally attached by rivets to the forked extensions of bushings which are adapted to slide along the external legs.

17. The bag supporting frame assembly of claim 17 wherein when the connecting arm and yoke assembly are in a raised position, the wheels are positioned in a widespread relation to each other.

18. The bag supporting frame assembly of claim 18 wherein when the handle is pivoted downwardly causing a downward movement of the connecting arm and a resultant inward and forward folding of the legs due to the downward movement of the yoke assembly.

19. The bag supporting frame assembly of claim 19 wherein raising of the handle automatically unfolds the legs to prepare the cart for normal duty.
